(19) United States
(12) Patent Application Publication
(10) Pub. No.: US 2009/0166384 A1
(43) Pub. Date: Jul. 2, 2009

(54) HydraFiller 1000

(76) Inventor: Jason Alderink, (US)

Correspondence Address: Jason Alderink, 16272 E. 100th Street, Foley, MN, 56329, US

(21) Appl. No.: 12/003,796

(22) Filed: Jan. 2, 2008

(51) Int. Cl. G01F 11/20

(52) U.S. Cl. 222/413

(57) ABSTRACT

A bucket/hopper for moving any fluent solid into a tube, bag, or sock. The bucket/hopper comprises: an elongated hopper having two opposite end portions and an open top side portion; an elongate auger to facilitate non-jamming operation, extending along the bottom portion of the hopper with a free-floating discharge end; a hydraulic drive means positioned adjacent to one end of the hopper and releasably connected to the drive end portion of the auger; a chischarge chute positioned in the other end portion of the hopper encircling the floating discharge end portion of the auger; and means to attach and maneuver the hopper from a long side portion thereof with a pre-manufactured weld-on plate, enabling an operator thereof to view, meter, and accurately position the discharge end of the auger. The auger is driven by a hydraulic pump. The bucket/hopper has dramatically reduced labor required to produce erosion control logs.

### STATEMENT REGARDING FEDERALLY SPONSORED RESEARCH OR DEVELOPMENT

No federal funds were used in the research or development of the HydraFiller 1000.

### CROSS-REFERENCE TO RELATED APPLICATIONS

| | | |
|---|---|---|
| 2397305 | March 1946 | Wheat |
| 2851171 | September 1958 | Martin et al. |
| 3337068 | August 1967 | J. L. MEHARRY |
| 4697998 | Oct. 6, 1987 | Steven J. Zumbusch |

### REFERENCE TO A SEQUENCE LISTING, A TABLE, OR A COMPUTER PROGRAM, LISTING COMPACT DISC APPENDIX

none

### BACKGROUND OF THE INVENTION

The HydroFiller 1000 is an original prototype designed in response to a growing need for erosion control products which are most commonly used in the construction industry. Originally designed as an improved method for the manufacture of erosion control logs, this prototype has a broad range of applications. It can be used to move a large volume of any fluent solid into a variety of tubular containers.

### BRIEF SUMMARY OF THE INVENTION

The HydraFiller 1000 invention is a unique combination of existing mechanical instruments. This invention is a hydraulic machine attachment made primarily of galvanized steel. It is designed to be attached to a skid loader or tractor. It consists of a uniquely designed maneuverable bucket which, when in the upright position, becomes a hopper. This bucket/hopper feeds an attached auger, located at the bottom of the bucket/hopper which moves any fluent solid material through an attached pipe and into a tube, bag or sock.

### BRIEF DESCRIPTION OF THE SEVERAL VIEWS OF THE DRAWING

FIG. 1 is a left sided view of the bucket/hopper showing the hydraulic motor placement.

FIG. 2 is a top view showing the hydraulic motor, auger placement and filler tube.

FIG. 3 is a right sided view of the bucket hopper showing the filler tube placement, as well as the mounting assembly and standard quick-attach plate.

### DETAILED DESCRIPTION OF THE INVENTION

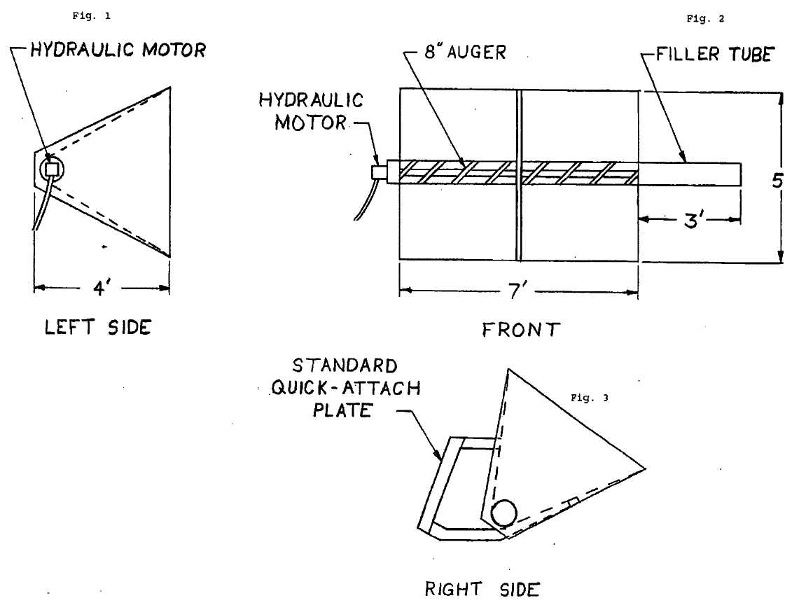

The attachment consists of a V-shaped hopper with an auger at the bottom (FIG. 1, 2). The hopper is 7 ft. wide, 4 ft. deep at the top, narrowing to a 1 ft. depth at the bottom. It is 4 ft. tall. The body of the hopper is fabricated from 12 gage sheet metal. The four pieces-two sides, front and back, are stitch welded together using basic mig welding techniques. Both sides of the hopper are identical, sides of the hopper are 5 ft. wide at the top, narrowing at a 70 degree angle to a 1 ft. base. A 10 ft. piece of 12 gage steel pipe with a 8 inch diameter is used to house the auger. To feed the auger, the front of the hopper is a rectangular sheet of galvanized steel 7 feet wide and 4 ft. tall, with a 4 inch×5 ft×½ inch cutting edge continuous welded to the leading edge of the hopper. The back of the hopper is also a rectangular sheet 7 feet wide and 4 ft. tall, with additional mounting for attaching to a skidsteer. Both the front and back panels have a support bar made of 2×2×0.25 in. square steel tubing running the width of the attachment, stitch welded 23.5 inches up from the bottom of the panel. Both the side panels have a circular hole cut one inch up from the bottom. These holes are 8 inches in diameter, and are centered evenly between the two edges.

The top of the hopper/scoop (FIG. 2) has a 1 inch rolled edge all the way around, with a support bar made of 2×2×0.25 in. square steel tubing centered and attached to the front and back directly below the rolled edge. The support bar is attached using a continuous weld.

The front of the hopper also serves as a scoop to pick up the fluent solid and fill the hopper. Therefore it is reinforced from the feet with additional 2×6×0.25 in. rectangular steel tubing, attached from the end of each foot at a 90 degree angle to the main horizontal support tube using continuous weld. There are also four additional supports that run along the profile of the front from the feet of the attachment to the main horizontal support. These four pieces consist of 1.5×1.5×0.25 angle iron, and are 28 inches long. The four pieces are attached, two on each left side foot support and two on each of the right sided foot support. These pieces are 24.5 inches long each. There is also a 28 inch piece support made of 1.5×1.5×0.25 in. angle iron welded between the two feet at the front edges. From the main support to the cutting edge are support slats attached to the sheet metal. These slates are 2×0.25 in. flat stock. There are five pieces that are 46.5 inches long. Two pieces are placed against the outside edges of the front panel, a third is placed in the center, and the remaining two are attached 20 inches off center on each side. They are attached using a stitch weld on vertical sides, continuous weld on horizontal sides.

The mounting is made of a pre-manufactured skidster plate, called a “weld-on plate,” attached at an 80 degree angle to the hopper using 2×6×0.75 in. retangular tubing (FIG. 3). The base of the attachment is created using using two pieces of 2×6×0.25 in. retangular tubing. Both pieces are 42 inches long, with the last 10 inches raised at a 45 degree angle using a notch out welding technique. These two base pieces are welded to the bottom of the skidster plate using a continuous weld. The plate is further supported at the top by 2×2×0.25 in. square steel tubing attached from the skidster plate to the reinforcement bar using a continuous weld at both ends. There are also 1.5×1.5×0.25 in. square steel tubes attached from the top corners of the skidster plate to the outside edge of the hopper at the reinforcement bar. These pieces at 24.5 inches long, and are attached using a continuous weld. Two additional pieces of the same tubing are attached from the two base pieces to the main support bar at a virtical 90 degree angle. Finally, 0.25 angle iron is attached from the interior edge of the skidster plates to the base pieces. These pieces are 29 inches long, and attached at 32.5 degree angle using a continuous weld.

At the bottom of the hopper, and auger in attached encase in a steel pipe (FIG. 2, 3). The pipe is 8 inches in diameter, 10 feet long, made of 12 guage steel. The pipe is attached to the hopper such that, from the front, the pipe meets the hopper on the right hand side, and extends out from the hopper on the left hand side 36 inches. The section of pipe under the hopper is cut in half at from 0 to 7 feet of the 10 ft. length of pipe to create an opening to attach the hopper. The steel pipe is then placed into the two 8 inch side openings with the 7 foot pipe opening placed fully inside the hopper and facing upward, with the remaining 36 inches of pipe extending out from the right side. The pipe is continuously welded to the front, back and both sides. Inside the pipe is placed a pre-manufactured auger with 7.25 fluting that is 0.25 inch thick, with a 1.25 ID pipe inside the fluting. The auger is 9 ft 6 inches long. The 1.25 shaft protrudes out of the right side of the hopper four inches, through a 1.25 pillow block, which is mounted to the right side panel using four standard 0.74×1.5 bolt assemblies. The auger free floats on the outlet side.

The auger is powered using a hydraulic motor (FIG. 1, 2). An Eaton Corp. 104-1026-006 model hydraulic motor was used. The motor is attached to the hopper using three 0.25 gauge steel plates. Two of the three plates are 5×6 inches, and one is 5×10 with a 0.75 ID opening placed dead center in the plate for the pump flange. The 10 inch plate also has two 0.5 inch holes placed 2.5 inches off center to the left and two the right for bolting the motor to the plate. The two 6 inch plates are attached at 90 degree angles to each end of the 10 inch plate, attaching the five inch sides of smaller plates to the five inch sides of the larger plate at 90 degree angles. Once attached to the 10 inch mounting plate, the two 6 inch support plates are then welded to the hopper body. A continuous weld technique was used throughout.

The hydraulic motor uses two 4000 psi hoses, 10 ft. long each with standard quick attachments.

The motor is attached to the auger shaft using 1.25×3×0.5 inch collar with a 3.16th key way. This collar provides a separation point to protect the auger shaft, should the pressure of the fluent material become to great. The collar is made with at 2.5 inch solid steel rod which was drilled out to 1.25 inside diameter with a 0.25 keyway at standard depth. One side has a ⅜ inch hole drilled through the diameter of the pipe one inch in from the end of the collar. A ⅜×2.5 inch grade 8 bolt is placed through the hole and the auger to attached the collar to the shaft of the auger. The shaft of the hydraulic motor fits into the other side of the collar and drives the auger.

While the invention has been described with preferred specific embodiments thereof, it will be understood that this description is intended to illustrate and not to limit the scope of the invention, which is defined by the following claims.

I claim:

1. A v-shaped bucket/hopper for use with a skid loader or tractor comprising
a. An elongated hopper having two opposite end portions and an open top side portion so that the hopper may be filled along the open top side portion;
b. An elongated auger to facilitate non-jamming operation, extending along the bottom portion of the hopper with a free-floating discharge end;
c. hydraulic drive means positioned adjacent to one end of the hopper and releasably connected to the drive end portion of the auger;
d. a discharge chute positioned in the other end portion of the hopper encircling the floating discharge end portion of the auger;
e. means to attach and maneuver the hopper from a long side portion thereof with a pre-manufactured weld-on plate, enabling an operator thereof to view, meter, and accurately position the discharge end of the auger.

2. A hopper as in claim 1 further comprising a frame which supports the trough.

3. A hopper as in claim 1 further comprising a blade member mounted on and around the top side portion of the bucket/hopper to facilitate scooping with the hopper.

4. A hopper as in claim 1 wherein the drive means comprises an hydraulic pump which is adapted to be removably connected to the auger
